(19) United States
(12) Patent Application Publication
(10) Pub. No.: US 2006/0069549 A1
(43) Pub. Date: Mar. 30, 2006

(54) Updating of a buried data channel

(75) Inventor: Arnoldus Werner Johannes Oomen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/552,078

(22) PCT Filed: Mar. 31, 2004
(86) PCT No.: PCT/IB04/50369

§ 371 Date: Oct. 4, 2005

(30) Foreign Application Priority Data
Apr. 8, 2003 (EP) 03100945.9

(51) Int. Cl. G10L 21/00

(52) U.S. Cl. 704/206

(57) ABSTRACT

The present invention relates to methods, devices, a media signal as well as a recorded medium relating to a media signal having audio samples including a buried data channel (30, 32, 34, 36). The buried data channel (30, 32, 34, 36) provided in the audio samples of a media signal includes information about the spectral shape of the buried data channel (30, 32, 34, 36). In this way data in the buried data channel (30, 32, 34, 36) can be updated in a simple manner without having to analyse the media signal.

### TECHNICAL FIELD

The present invention generally relates to the field of consumer electronics and more particularly to the updating of additional data provided in audio samples of a media signal.

### DESCRIPTION OF RELATED ART

There is a need for providing additional retrievable information related or non-related to audio samples of a media signal. This additional information can be such things as an additional comment for example displayable subtitles or text, an additional sound channel, multilingual speech service, Karaoke or video. The information can also be information about number of copies allowed to be made by a content purchaser.

WO-A-95/18523 describes the use of a buried data channel in the least significant bits of samples of coded sound for such additional data. The document also describes the use of special processing in order to determine how much of the samples can be used for the data channel. In this respect the sound spectrum is analysed and a masldng error is determined, below which the influence of the information in the buried data channel is to be provided in order not to be perceptible.

There is in relation to this a need for a content purchaser to be able to update the additional data One such example is that a holder of a certain piece of content might be allowed to make a number of copies of the content. It would therefore be advantageous if the content could include additional information that can be influenced by a user, like changing the value of a copy counter. Other examples might include the insertion of own comments to a piece of audio.

When updating the data in the buried data channel, there is often performed so called tandem coding of the actual audio signal, which means that the samples of the media signal are subjected to several steps of encoding and decoding. When this is done the spectral shape of the additional information is lost, which means that in order to insert the new additional data into the samples, the above mentioned analysis would have to be repeated again in order to determine how the updated data is to be inserted without being perceptible. Apart from being complicated to perform, the device doing this would also become more expensive, which is disadvantageous if the device is intended for a consumer market.

There is therefore a need for a way to be able to insert data in a buried data channel, which allows the variation of the data as well as enables the variation to be made without degrading the sound quality and without making the device performing the data variation/addition more complex and thus more expensive.

### SUMMARY OF THE INVENTION

It is thus an object of the present invention to provide a way for varying the buried data in a buried data channel of a media signal comprising audio samples without having to analyse the media signal for providing the updated buried channel.

According to a first aspect of the present invention, this object is achieved by a method of allowing variation of data in a buried data channel provided in a media signal, which comprises at least one set of audio samples of digital audio information, comprising the steps of:

providing a buried data channel having a certain spectral shape in the audio samples of the media signal,

inserting payload data in the buried data channel, and inserting information corresponding to the spectral shape of the buried data channel into the buried data channel.

According to a second aspect of the present invention, this object is also achieved by a method of varying data buried in a media signal comprising at least one set of audio samples of digital audio information, comprising the steps of:

extracting information corresponding to the spectral shape of a buried data channel from said buried data channel, which channel comprises payload data and is provided in at least some of the audio samples,

updating the payload data,

inserting data including the updated payload data in at least some audio samples, and

using said spectral shape information for modifying the spectral shape of the data in the buried data channel having the updated payload data.

According to a third aspect of the present invention, this object is furthermore achieved by a device for inserting information allowing variation in the data of a buried data channel provided in a media signal, which comprises at least one set of digital audio samples, comprising:

a digital media source input for receiving at least one set of digital audio samples, and

a data inserting unit arranged to:

provide a buried data channel having a certain spectral shape in the audio samples of the media signal,

insert payload data in the buried data channel, and

insert information corresponding to the spectral shape of the buried data channel into the buried data channel.

According to a fourth aspect of the present invention, this object is also achieved by a device for varying data buried in a media signal comprising at least one set of audio samples of digital audio information, comprising:

a control unit arranged to extract information corresponding to the spectral shape of a buried data channel from said buried data channel, which channel comprises payload data and is provided in at least some of the audio samples,

a buried data processor arranged to update the payload data, and

a data inserting unit arranged to insert data including the updated payload data in at least some of the audio samples using said spectral shape information for modifying the spectral shape of the data in the buried data channel having the updated payload data.

According to a fifth aspect of the present invention, this object is also achieved by media signal comprising at least one set of audio samples of binary audio information, comprising:

a buried data channel in at least one of the audio samples comprising information corresponding to the spectral shape of the buried data channel.

According to a sixth aspect of the present invention, this object is also achieved by a recorded medium comprising a media signal including at least one set of audio samples of digital audio information, which signal comprises:

a buried data channel in at least one of the audio samples comprising information corresponding to the spectral shape of the buried data channel.

Claims 3, 11, 19 and 26 are directed towards providing information about spectral shape in a number of coefficients that can be used for a filter.

Claims 4, 13 and 20 are directed towards providing the spectral shape information in a way that reduces the errors when applied on a filter.

Claims 5 and 23 are directed towards determining spectral shape information.

Claims 6 and 18 are directed towards providing the spectral shape information in the header of the buried data channel.

The present invention has the advantage of allowing a less complex and cheaper encoder, when re-encoding the audio samples of a media signal with an updated buried data channel.

The general idea behind the invention is thus to provide information about the spectral shape of a buried data channel provided in the buried data channel that is present in a media signal.

The expression payload data is intended to comprise data having informational content as opposed to data used for controlling the provision of a buried data channel.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIG. 1 shows a block schematic of a system using spectral shape information according to the invention,

FIG. 2 shows a block schematic of a device for inserting spectral shape information into the samples of a media signal according the invention,

FIG. 3 shows a signal according to the invention with a frame of a number of audio samples having a buried data channel,

FIG. 4 shows a header of the buried data channel in FIG. 3,

FIG. 5 shows a block schematic of a device for extracting and using spectral shape information from the buried data channel according to the invention,

FIG. 6 shows a flow chart of a method for inserting spectral shape information into a buried data channel according to the invention,

FIG. 7 shows a flow chart of a method for extracting and using the spectral shape information in relation to a buried data channel according to the invention,

FIG. 8 shows a block schematic of a unit for inserting data into a buried data channel according to the invention,

FIG. 9 shows an optical disc on which a media signal having the buried data channel with the spectral shape information according to the invention is stored.

### DETAILED DESCRIPTION OF EMBODIMENTS

The present invention relates to the field of providing additional information in digital media signals having audio samples. The media signal is in the preferred embodiment an audio signal. The invention is however not limited to audio but can be applied for other media signals like for instance video when including audio samples.

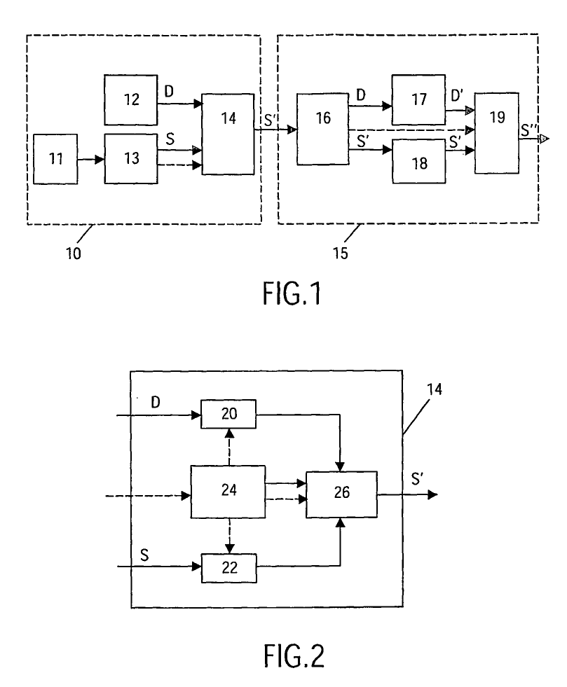

FIG. 1 shows a block schematic of a device according to the invention. The device includes a first device 10 on a sender side for providing additional information in the audio samples of the media signal, i.e. for inserting information allowing variation of data in a buried data channel, and a second device 15 on a receiver side for extracting the additional information in the audio samples of the media signal and for varying data buried in the media signal. The first device 10 includes an audio sample source 11, including a number of audio samples in the form of PCM (Pulse Code Modulation) samples, for instance in one or more songs provided in a CD record. The source 11 is connected to an audibility determination or masked error spectrum generating unit 13, which provides audibility thresholds for audio samples with a limited part of a number of samples like a frame containing 1152 samples. Unit 13 is connected to a data inserting unit 14 and provides the samples S as well as audibility threshold information (shown with a dashed line), which is used for determining the size of the buried data channel and filter coefficients for providing the spectral shape of the buried data channel. The unit 14 thus has an input for receiving PCM samples S and an input for receiving the audibility threshold information. The data inserting unit 14 is also connected to a data providing unit 12, which provides data D, hereafter denoted payload data, to be buried in the PCM samples to the data inserting unit 14. The data inserting unit 14 sets up a buried data channel in the audio samples S where the payload data is provided. The size of the channel is determined by the received audibility threshold information. The data inserting unit 14 provides samples S′ that include the buried data channel. The device 15 receives the PCM samples S′ having the buried data channel in a receiving unit 16. The payload data D in the buried data channel is extracted and provided to buried data processor 17. The received PCM samples S′ are also provided to an audio processor 18 and thus the buried data is kept in the samples even for the audio processor. The device 15 also includes a data inserting unit 19 of basically the same type as the data inserting unit in device 10. This unit 14 receives updated data D′, PCM samples S′ as well as synchronisation and allocation data and spectral shape information (shown with a dashed line) from the control unit 16. The data inserting unit 19 provides PCM samples S″ with a buried data channel having updated payload data D′.

The payload data D provided by the data providing unit 12 and by the buried data processor 17 can be in the form of additional comments such as displayable subtitles or text an additional sound channel, multilingual speech service, Karaoke or video. It can also include information such as number of allowable copies to be made of a certain piece of content. The data can furthermore also include watermarks, which in the case of the buried data processor 17 can be changed or updated watermarks.

FIG. 2 shows a block schematic of the data inserting unit 14, which includes a first buffer 20 for receiving the payload data D to be inserted in the buried data channel and a second buffer 22 for receiving the PCM samples S. In the second buffer, the PCM samples are quantized to samples of a smaller size in order to provide space for payload data D. The block also includes a control unit 24, which determines synchronisation and allocation information for the buried data channel based on the received audibility threshold information. The control unit 24 also determines the spectral shape of the buried data channel and filter coefficients to be used for providing this spectral shape. The control unit 24 provides the first and second buffers 20 and 22 with information about how many bits of each original PCM sample S are to include buried data. This determination is done dynamically for a number of blocks of samples based on the information from the audibility determining unit. The control unit 24 and the two buffers 20 and 22 are also connected to a combiner 26, in which the data is inserted in the least significant empty bits of the recoded PCM samples. The control unit 24 also forwards synchronisation and allocation information as well as information on the spectral shape of the buried data channel to the combiner 26 for inserting in the buried data channel. The data updating unit 19 on the receiver side includes the same units as unit 14 on the sender side. There the control unit is however slightly different.

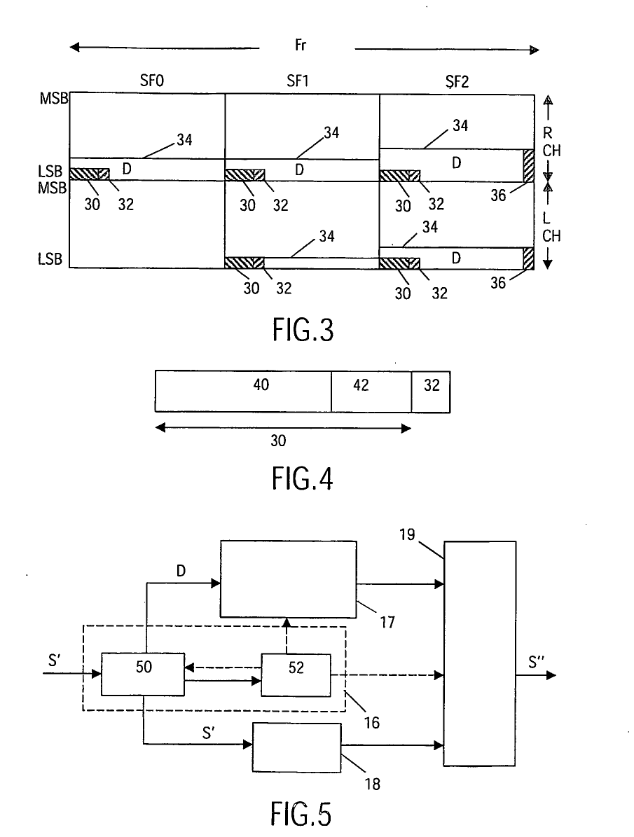

A CD audio signal normally comprises two channels a left and a right channel in which buried data can be inserted. FIG. 3 generally shows how to provide a buried data channel in both these channels. First of all the samples are divided into frames Fr, where a frame consists of 1152 PCM samples. Each frame Fr is then subdivided into three different subframes SF0, SF1 and SF2. It is always possible to provide the two least significant bits of each PCM sample as a buried channel and therefore the two least significant bits can always be provided for a header including allocation and synchronisation information, which is used for indicating the nature of the buried data payload. In FIG. 3 there is shown two channels a right and a left channel R CH and L CH for a frame Fr. A buried data channel is provided in each channel. The right channel R CH includes a buried data channel in all of its subframes, while the left channel L CH only includes a buried data channel in the second and third subframe SF1 and SF2. The first samples of subframes containing a buried channel always includes a field or header 30 with synchronisation and allocation information, to which is appended a CRC-check 32. This part is provided in the part of the buried channel always available. This information thus indicates how big the buried data channel is as well as if and in which samples a buried data channel is provided. According to the invention the header also includes information regarding the spectral shape of the buried data channel. Depending on the properties of the PCM samples, more or fewer bits can be provided for payload data 34, where the right channel R CH is shown having more such space in the first and second subframes SF0 and SF1, while the third subframe SF2 of this channel has an even higher capacity. The left channel L CH does not have any extra capacity in the second subframe SF1, while it has some more capacity in the third subframe SF2. The capacity is decided on a subframe-by-subframe basis through the previously mentioned audibility threshold information. The payload data 34 here includes the above mentioned data intended to be processed on the receiver side. The last subframe is provided with a CRC check 46 at the end in the buried channel. This CRC check is provided for error correction of the payload data

FIG. 4 generally shows the header 30 with the CRC-check 32. The header thus includes a synchronisation and allocation field 40 as well as a field 42 including information about the spectral shape of the buried data channel, which information thus is provided in digital form.

FIG. 5 shows a block schematic of a receiver or device for varying data buried in the PCM samples. The receiving unit 16 includes an input buffer 50, where the PCM samples S′ are received, a control unit 52, which extracts the synchronisation and allocation information as well as the spectral shape information from the buried data channel and provides all the received PCM samples S′ to the audio processor 18. The data payload is then provided to the buried data processor 17 in dependence of the synchronisation and allocation information. The buried data processor updates the payload of the buried data, for instance by decrementing or incrementing a copy counter in the payload data or by changing a watermark and forwards this to the data inserting unit 19 of the receiving device. In the same manner, the audio processor 18 also provides PCM samples to the data inserting unit 19, perhaps when in the process of making a copy of the content or audio samples and after having made several steps of encoding and decoding. The control unit 52 also forwards the spectral shape information to the data inserting unit of the receiving device. It also forwards the extracted synchronisation and allocation information. The data inserting unit 19 then inserts the updated data into the buried data channel using the synchronisation and allocation information as well as the spectral shape information. How this is done will be explained in more detail later on. The data inserting unit 19 is, as was mentioned previously essentially the same as the unit 14. There is one difference though. The control unit of the data inserting unit 19 does not have to determine synchronisation and allocation information or to determine the suitable spectral shape of the buried data channel, since this has already been done.

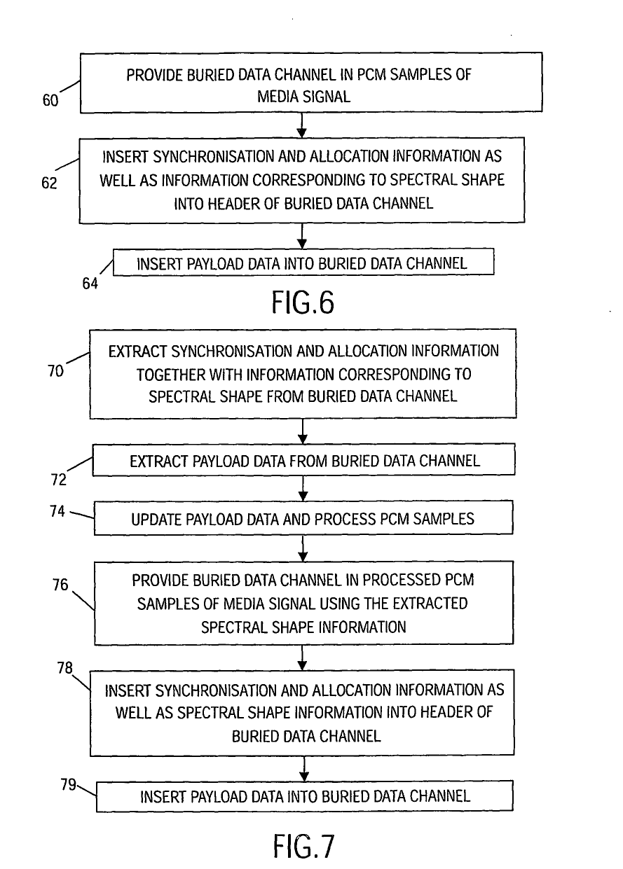

The methods according to the invention will now be shortly described with reference to FIGS. 6 and 7, showing the method steps carried out on the sender and receiver sides.

First the buried data channel is provided in the PCM samples of the media signal having a certain spectral shape, step 60. The data channel is provided with a certain spectral shape so that the data in the buried data channel influences the perception of the audio as little as possible. The size of the channel is also, as was described previously, determined based on the properties of the audio in the samples. Thereafter synchronisation and allocation information as well as information relating to the spectral shape of the channel is inserted in the header portion, step 62. After that the payload data is inserted in the channel, step 64. This synchronisation and allocation information is calculated on a subframe-by-subframe basis based on the properties of the PCM samples, as is the spectral shape information. The synchronisation and allocation information, information relating to the spectral shape of the channel and payload data are here provided in all subframes of each frame that includes a buried data channel.

On the receiving side synchronisation and allocation information as well as information relating to the spectral shape of the channel is extracted from the buried data channel, step 70. Thereafter the payload data is extracted from the buried data channel based on this information, step 72. The payload data is provided to the buried data processor, which updates the payload, step 74. At the same time the audio processor also processes the PCM samples, step 74, for instance by making allowable copies. For a copy of the audio, then a buried data channel is again provided in the PCM samples, step 76. In this channel the previously extracted information relating to the spectral shape is used together with the synchronisation and allocation information in order to provide the channel. Thereafter the synchronisation and allocation information and the spectral shape information are inserted into the header of the newly created buried data channel, step 78. This is finally followed by insertion of the updated data into the payload of the buried data channel, step 79.

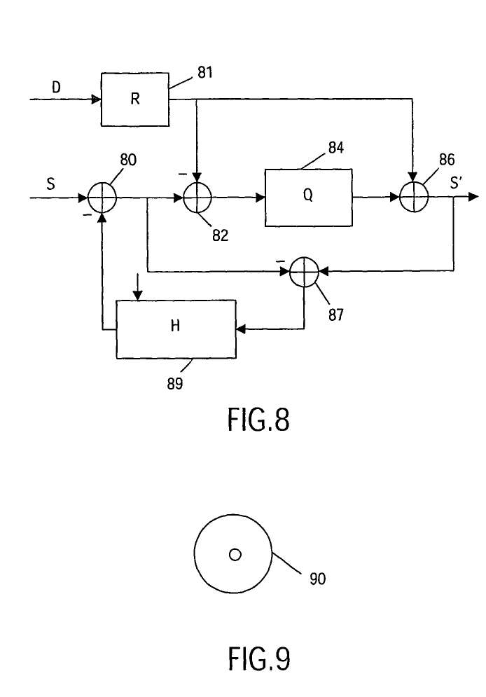

In FIG. 8 there is shown how the insertion of data D can be performed in more detail. The data D for provision in a buried data channel is randomised by a randomising unit 81 using a randomising function R The original PCM samples S are provided to a first subtracting unit 80, to which the output of a noise shaping unit 89 shaping noise with a function H is connected. This noise shaping unit is in one embodiment a FIR filter. The first subtracting unit 80 is connected to a second subtracting unit 82 to which the output of the randomising unit 81 is also connected. The second subtracting unit 82 is connected to a quantisation unit 84 having a quantisation function Q, where the output of the quantisation unit 84 is connected to an adding unit 86, to which adding unit 86 is also connected the output of the randomising unit 81. The adding unit 86 also provides an output signal S′. The output signal S′ is provided to the receiver side, but is also provided to a third subtracting unit 87, which is also connected to the first subtracting unit 80. The third subtracting unit 87 is furthermore connected to the input of the noise shaping unit 89.

The functioning of the device in FIG. 8 is the following. Data D for a buried data channel is provided to the randomising unit 81, which randomises the data according to a reversible randomising function R, which additional data will make up a number of least significant bits of the audio samples. The randomisation can be provided through a CRC-circuitry comprising a tapped delay line and a number of exclusive-or units, which perform exclusive-or combinations on the delayed input data bits. These randomised least significant bits are thus provided in the form of dither and first subtracted from the PCM samples S. The resulting signal from the subtraction is then quantised in the quantisation unit 84 such that a number of least significant bits are discarded from the PCM samples. The number of bits discarded are, as mentioned before, determined dynamically by analysing the audibility threshold and in this case the masked error spectrum of the PCM samples. To this quantized signal is then added the data D in the form of the randomised least significant bits or dither, where the number of bits inserted are also determined by the dynamic analysis of the masked error spectrum. The result is provided as a signal S′ with the PCM samples including the buried data channel. The third subtracting unit 87 provides an error signal between the input PCM samples S and the output PCM samples S′, which is provided to the noise shaping unit 89. The noise shaping unit 89 is a noise shaping filter that shapes the white noise floor based on the error signal and subtracts it from the input signal S. The functioning of the device is described in more detail in WO-A-95/18523, which is herein incorporated by reference.

The device in FIG. 8 can be used in any of the data inserting units. However since the filter coefficients and the timing and allocation information have been provided in the signal, there is no need for the audibility determining unit and its functionality on the receiver side. There is also no need for determining the filter coefficients in the control unit of the data inserting unit. This greatly simplifies the receiving side and also makes it cheaper to produce.

What is inserted into the header of the buried data channel is information about filter coefficients to be used in the noise shaping unit 89. By doing this the receiving side need not determine a masked error spectrum and then determine these coefficients based on the spectrum, but can use this information directly on the noise shaping unit. There is a need for this since in for instance the process of copying content, there might be performed so called tandem coding, where the PCM samples are subjected to several steps of coding and decoding. In these instances the spectral shape information is normally lost. If the data in the buried data channel is to be varied, i.e. inserted again, there is a risk that the audio quality is perceptibly degraded if no white noise floor is inserted.

The filter coefficients provided in the buried data channel are quantized version of the floating-point parameters, which in a preferred embodiment are provided in the form of LOG-Area ratios. This is done in order to minimise the differences between the absolute values of the parameters, which can be significant. These differences can otherwise give rise to unnecessary errors. There are also other ways to provide the filter coefficients. Other ways are to transform them into other domains such as reflection or Parcors parameters. They can of course also be provided as direct binary representations of the floating-point values.

Above was mentioned that the payload data was coded using a dither coding function R. In order to decode this data, the buried data processor also includes an inverse coding function R⁻¹ for decoding the dither. It is preferred not to encode the header with the coding function R in order to locate and decode the information more easily. Because of the small size of the header, it will in any way have a negligible influence on the perception of the audio It is however possible to encode also the header.

The invention can be varied in many ways. For instance the data in the buried data channel can be provided without using the randomising function R, but then there is a risk that the quality of the audio signal is perceptibly degraded. It should also be realised that any suitable transmission channel can provide the channel between the sender and receiver side. The control unit on the receiver side need not extract the payload data for provision to the buried data processor. It is therefore also possible for the buried data processor to directly provide new data for the buried data channel, without receiving the data provided therein. The spectral shape information as well as the synchronisation information can be decided on a frame-by-frame basis instead of on a subframe-by subframe basis. The media signal can also be stored on a storage medium, such as a CD disc, which can then be provided to the receiving side in a suitable manner in order to provide the channel. FIG. 9 shows one such disc 90. There does also not have to be two channels of audio samples, i.e. left and right, but the invention can just as well be used using only one channel of audio samples. The receiving side need furthermore not have to process the audio. The spectral shape information does also not have to be provided in the updated buried data channel.

1. Method of allowing variation of data in a buried data channel (30, 32, 34, 36) provided in a media signal (S), which comprises at least one set of audio samples of digital audio information, comprising the steps of:
providing a buried data channel (30, 32, 34, 36) having a certain spectral shape in the audio samples of the media signal, (step 60),
inserting payload data (D) in the buried data channel, (step 64), and
inserting information corresponding to the spectral shape (42) of the buried data channel into the buried data channel, (step 62).

2. Method according to claim 1, wherein the information corresponding to the spectral shape is digital.

3. Method according to claim 1, wherein the information corresponding to the spectral shape of the buried data channel comprises information about the number of coefficients to be used in a filter when updating the data of the buried data channel.

4. Method according to claim 3, wherein the coefficients are represented as quantised log-area ratio (LAR) coefficients.

5. Method according to claim 3, further including the steps of determining a masked error spectrum for the buried data channel, determining filter coefficients based on the masked error spectrum, determining number of bits to be inserted in at least one audio sample, and providing said coefficients to a filter for providing the spectral shape of the buried data channel.

6. Method according to claim 1, wherein the buried data channel comprises a header (30) and the step of inserting information corresponding to the spectral shape of the buried data channel comprises inserting the information in the header of the buried data channel.

7. Method according to claim 6, further including the step of inserting synchronisation and allocation information (40) in the header of the buried data channel, which information enables extraction of data in the buried data channel.

8. Method according to claim 1, further including the step of randomizing data to be inserted in the buried data channel in the form of dither coded for allowing decoding in order to retrieve the data.

9. Method of varying data buried in a media signal (S) comprising at least one set of audio samples of digital audio information, comprising the steps of:
extracting information corresponding to the spectral shape (42) of a buried data channel from said buried data channel (30, 32, 34, 36), which channel comprises payload data (D) and is provided in at least some of the audio samples, (step 70),
updating the payload data, (step 74)
inserting data including the updated payload data in at least some audio samples, (step 79), and
using said spectral shape information for modifying the spectral shape of the data in the buried data channel having the updated payload data, (step 76).

10. Method according to claim 9, further comprising the step of extracting payload data in the buried data channel, (step 72).

11. Method according to claim 9, wherein the information corresponding to the spectral shape of the buried data channel comprises information about a number of coefficients to be used in a filter when changing the data of the buried data channel.

12. Method according to claim 11, wherein the step of using said spectral shape information for modifying the spectral shape of the data in the buried data channel comprises using the spectral shape coefficients in a noise shaping filter used when inserting the data including the updated payload data in the buried data channel.

13. Method according to claim 11, wherein the coefficients are represented as quantised log-area ratio (LAR) coefficients.

14. Method according to claim 11, wherein the coefficients have been transformed into another domain.

15. Method according to claim 9, further comprising the step of extracting synchronisation and allocation information from the buried data channel (step 70) and extracting data in the buried data channel based on this synchronisation and allocation information.

16. Method according to claim 9, wherein the originally provided data in the buried data channel is provided as reversibly coded dither for allowing retrieval of data and the steps of extracting includes decoding the dither and further including the step of coding the data including the updated payload data with a dither function before the step of inserting the data in the audio samples.

17. Device (10) for inserting information allowing variation in the data of a buried data channel (30, 32, 34, 36) provided in a media signal (S), which comprises at least one set of digital audio samples, comprising:
a digital media source input for receiving at least one set of digital audio samples, and
a data inserting unit (14) arranged to:
provide a buried data channel (30, 32, 34, 36) having a certain spectral shape in the audio samples of the media signal,
insert payload data (D) in the buried data channel, and
insert information corresponding to the spectral shape of the buried data channel (42) into the buried data channel.

18. Device according to claim 17, wherein the data inserting unit is arranged to insert the information corresponding to the spectral shape of the buried data channel information in a header (30) of the channel.

19. Device according to claim 17, wherein the information corresponding to the spectral shape comprises information about a number of coefficients to be used in a filter when updating the data of the buried channel.

20. Device according to claim 19, wherein the coefficients are represented as quantised log-area ratio (LAR) coefficients.

21. Device according to claim 17, wherein the data inserting unit is arranged to insert synchronisation and allocation information (40) enabling extraction of data in the buried data channel.

22. Device according to claim 17, wherein the data inserting unit comprises a randomising unit (81) for providing data to be inserted in the buried data channel in the form of dither coded with a reversible coding function.

23. Device according to claim 17, wherein the data inserting unit further comprises a masked error spectrum generating unit (13) and a noise shaping unit (89) and is further arranged to combine the spectrum of the dither variation with the desired masked error spectrum and then provide this information to the noise shaping unit for forming a noise shaped signal for combining with the audio samples.

24. Device (15) for varying data buried in a media signal (S) comprising at least one set of audio samples of digital audio information, comprising:
a control unit (52) arranged to extract information corresponding to the spectral shape of a buried data channel (42) from said buried data channel (30, 32, 34, 36), which channel comprises payload data (D) and is provided in at least some of the audio samples,
a buried data processor (17) arranged to update the payload data, and
a data inserting unit (19) arranged to insert data including the updated payload data in at least some of the audio samples using said spectral shape information for modifying the spectral shape of the data in the buried data channel having the updated payload data.

25. Device according to claim 24, wherein the control unit is further arranged to extract payload data provided in the buried data channel.

26. Device according to claim 24, wherein the data inserting unit comprises a noise shaping unit (89) providing said spectral shape of the buried data channel and the control unit is arranged to extract information about a number of coefficients to be used in said noise shaping unit when extracting the spectral shape information and to provide these coefficients to the data inserting unit.

27. Media signal (S) comprising at least one set of audio samples of digital audio information, comprising:
a buried data channel (30, 32, 34, 36) in at least one of the audio samples comprising information corresponding to the spectral shape of the buried data channel (42).

28. Recorded medium (90) comprising a media signal including at least one set of audio samples of digital audio information, which signal comprises:
a buried data channel (30, 32, 34, 36) in at least one of the audio samples comprising information corresponding to the spectral shape of the buried data channel (42).
